(19) United States
(12) Patent Application Publication
(10) Pub. No.: US 2011/0126661 A1
(43) Pub. Date: Jun. 2, 2011

(54) INDUSTRIAL ROBOT

(75) Inventor: BO LONG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/768,064

(22) Filed: Apr. 27, 2010

(30) Foreign Application Priority Data
Nov. 30, 2009 (CN) 200910310667.0

(51) Int. Cl. B25J 17/00

(52) U.S. Cl. 74/490.05; 901/25; 901/19

(57) ABSTRACT

An industrial robot includes a joint, a first arm rotatably connected to the joint about a first rotation axis and defining a hollow portion extending along the first rotation axis, a second arm rotatably connected to the first arm about a second rotation axis, a third arm rotatably connected to the second arm about a third rotation axis, a first driver and a first transmission mechanism to drive the first arm, a second driver and a second transmission mechanism to drive the second arm, and a third driver and a third transmission mechanism to drive the third arm. The first, second and third drivers are mounted on the joint. The second transmission mechanism includes a first shaft rotatably received in the hollow portion, and the third transmission mechanism includes a second shaft sleeved on the first shaft.

### CROSS-REFERENCE TO RELATED APPLICATION

This application is related to a co-pending U.S. patent application Ser. No. 12/632,955, filed on Dec. 8, 2009, and entitled “ROBOT ARM ASSEMBLY AND INDUSTRIAL ROBOT USING THE SAME”. The inventor of the co-pending application is Bo Long. The co-pending application has the same assignee as the present application. The Specification and Drawings of the co-pending application are incorporated herein by reference.

### BACKGROUND

1. Technical Field

The present disclosure generally relates to robotic technologies, and particularly, to an industrial robot.

2. Description of Related Art

A commonly used industrial robot includes a fixed base, a frame pivotally connected thereto about a first rotation axis, a lower arm, one end of which is pivotally connected to the frame about a second rotation axis, and an upper arm, one end of which is pivotally connected to the other end of the lower arm about a third rotation axis. An actuator, such as a welding device, a gripper or a cutting tool, is mounted at a distal end of the upper arm of the industrial robot to execute specific tasks. Generally six axes are utilized to achieve maximum movement of the actuator.

In robots of this kind, each arm rotates around a rotation axis driven by a driving unit. Typically, the driving unit includes a motor mounted on the lower arm and a speed reducer coupled to the motor to transmit the movement of the motor to the upper arm. The speed reducer may be a high gear ratio gear, such as a harmonic gear reducer, a RV reducer (rotary vector reducer), or a planetary reducer. The motor and the speed reducer are arranged along the rotation axis of the arm, rendering the range along the rotation axis relatively large. In a six-axis industrial robot, the fifth arm is rotatably connected to the sixth arm and may be perpendicularly positioned. The fifth and sixth arms are respectively driven by two driving units arranged adjacent to each other, such that the combined fifth and sixth arms are relatively large. As a result, the industrial robot needs considerable space to operate freely and safely. In addition, the cables connected to the motors for transmitting signals and power are inserted into the inner of the robot, thus abrasion between the cables and the components of the robot is produced.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic plan view of one embodiment of an industrial robot.

FIG. 2 is an isometric view of a robot arm assembly, utilized in the industrial robot of FIG. 1.

FIG. 3 is a lateral view of the robot arm assembly of FIG. 2.

FIG. 4 is a cross section of the robot arm assembly of FIG. 2, taken along the line IV-IV.

FIG. 5 is an exploded, isometric view of part of the robot arm assembly of FIG. 2.

FIG. 6 is similar to FIG. 5, but viewed from another perspective.

### DETAILED DESCRIPTION

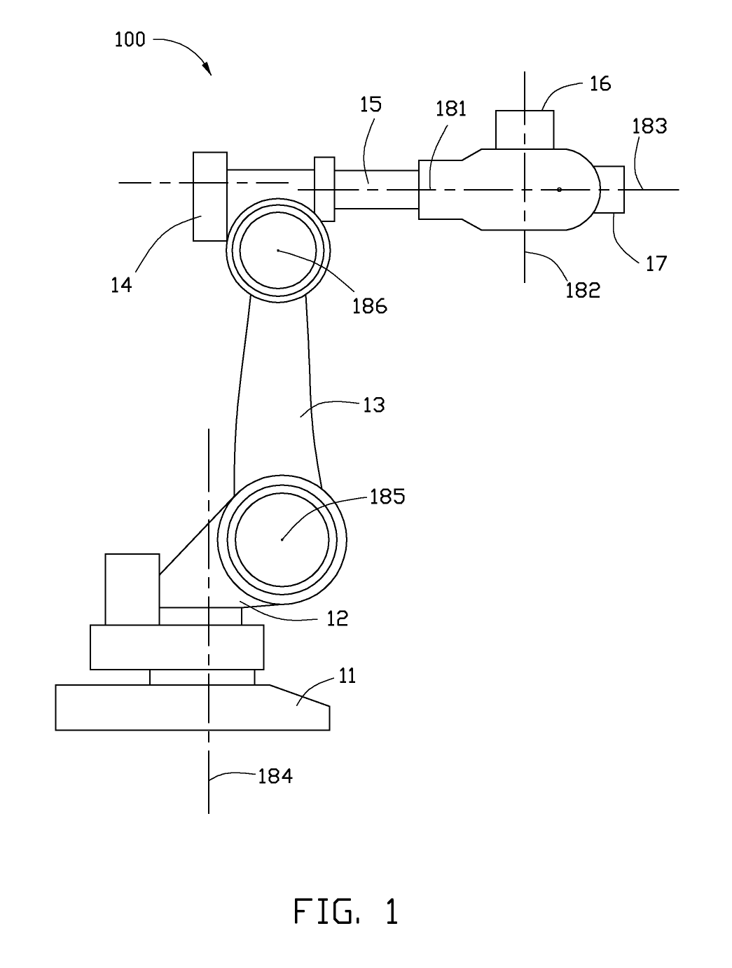

Referring to FIG. 1, one embodiment of an industrial robot 100 is illustrated. The industrial robot 100 may be a six-axis industrial robot and includes a fixed base 11, a bracket 12 pivotally connected to the fixed base 11, a lower arm 13 pivotally connected to the bracket 12, a joint 14 pivotally connected to the lower arm 13, and a first arm 15, second arm 16 and third arm 17 connected in sequence. The first arm 15 is rotatably connected to the joint 14 about a first rotation axis 181. The second arm 16 is rotatably connected to the first arm 15 about a second rotation axis 182. The third arm 17 is rotatably connected to the second arm 16 about a third rotation axis 183. In the illustrated embodiment, the first and third rotation axes 181, 183 are substantially perpendicular to the second rotation axis 182. The fixed base 11, the lower arm 13 and the joint 14 are rotatable about rotation axes 184, 185, 186, respectively. An actuator, such as a cutting tool, a clamping tool or a detector can be mounted on the distal end of the third arm 17 to perform a predetermined action.

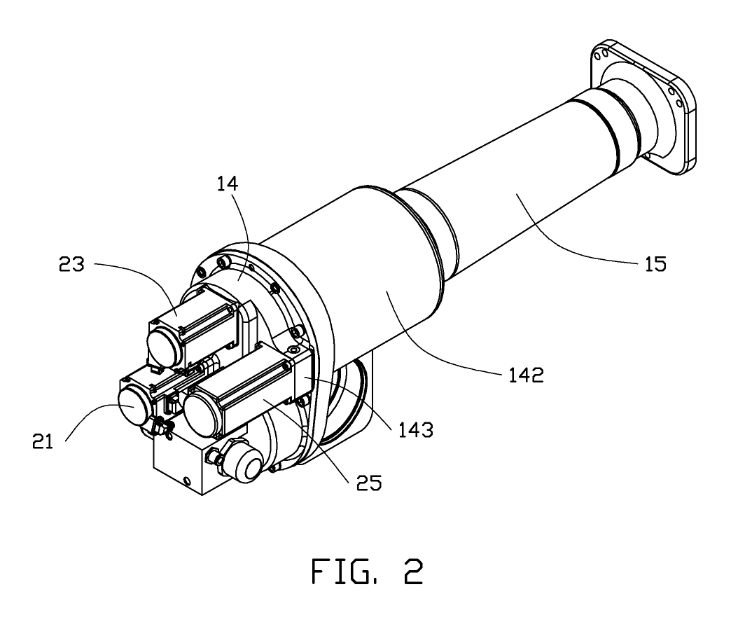

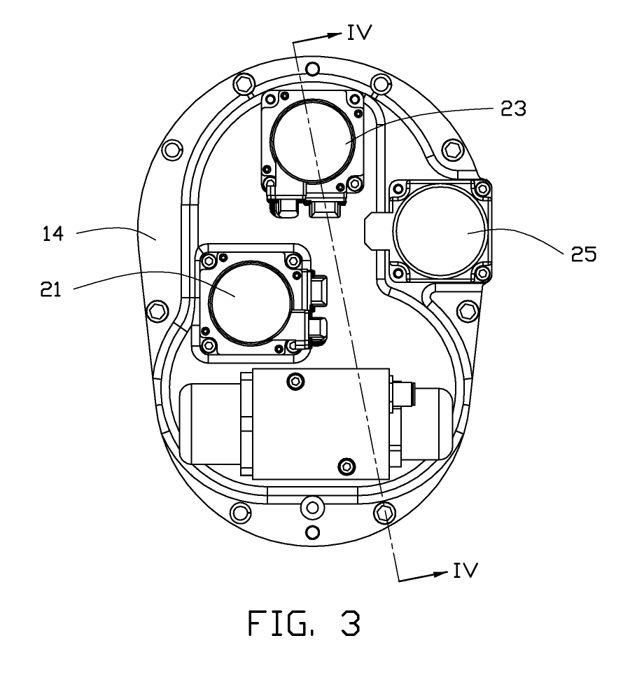

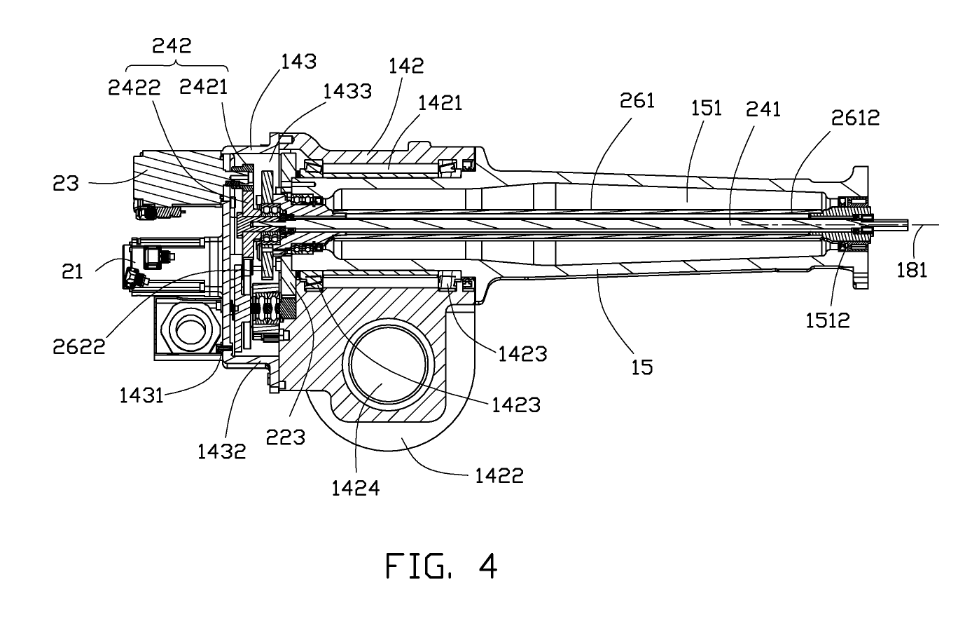

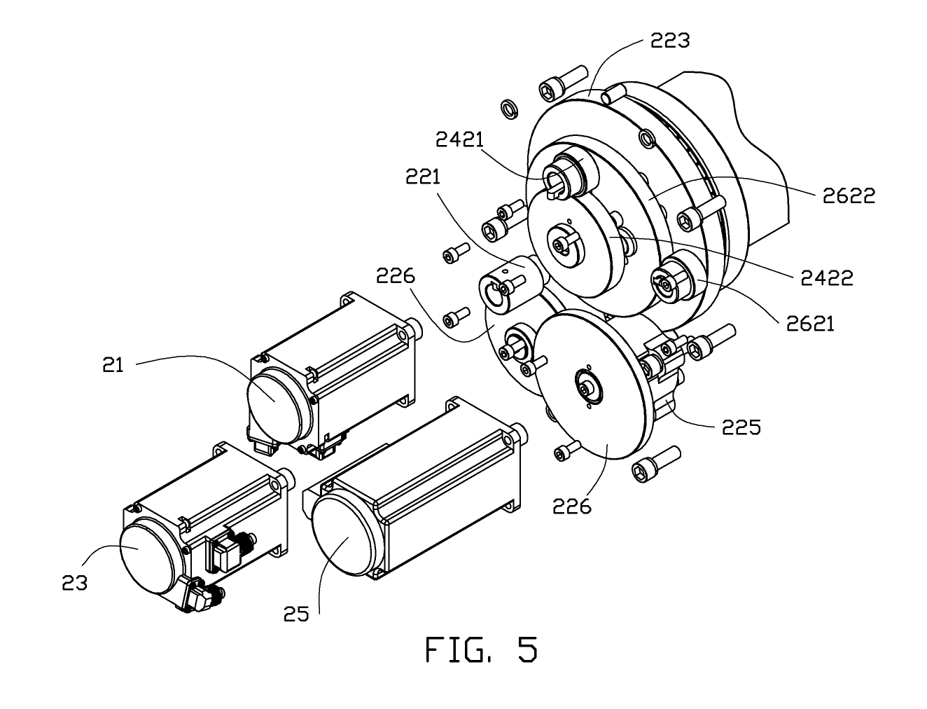

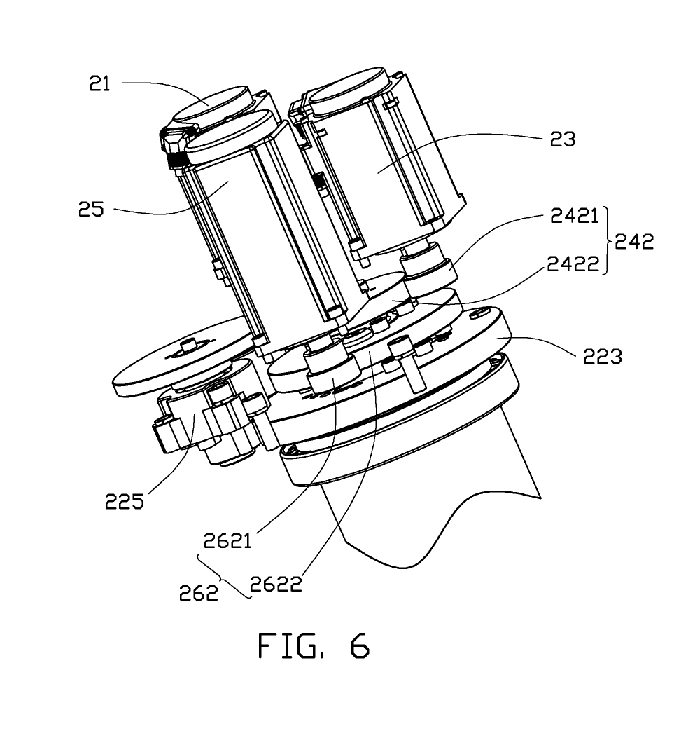

Referring to FIGS. 1 through 6, the industrial robot 100 is provided with a first driver 21 and a first transmission mechanism (not labeled) to drive the first arm 15, a second driver 23 and a second transmission mechanism (not labeled) to drive the second arm 16, and a third driver 25 and a third transmission (not labeled) to drive the third arm 17.

The joint 14 includes a first support portion 142 and a second support portion 143 fixed to the first support portion 142. The first support portion 142 defines a first assembly hole 1421 for receiving an end of the first arm 15. Two bearings 1423 are received in two ends of the first assembly hole 1421 to rotatably support the first arm 15. The first support portion 142 further includes a connection portion 1422 extending from the outer surface of the first support portion 142, which defines a connection hole 1424 therein, whereby the joint 14 is mounted to the lower arm 13 of the industrial robot 100.

The second support portion 143 includes a bottom surface 1431 and a sidewall 1432 extending substantially perpendicular to an outer edge of the bottom surface 1431. The bottom surface 2131 and the sidewall 2132 cooperatively define a receiving space 1433. The side of the sidewall 1432 away from the bottom surface 1431 is fixed to the first support portion 142. The receiving space 1433 communicates with the first assembly hole 1421 of the first support portion 142 The bottom surface 1431 defines three second assembly holes (not labeled) thereon. The first, second and third drivers 21, 23, 25 are mounted on the bottom surface 1431 of the second support portion 143. The output shafts of the drivers 21, 23, 25 are substantially parallel to each other and received in a corresponding second assembly hole, respectively. In such a manner, the cables connected to the drivers 21, 23, 25 can be drawn from the external space of the industrial robot 100, thus abrasion between the cables and the components of the industrial robot 100 can be avoided, in addition to facilitating the arrangement of the cables.

The first arm 15 defines a hollow portion 151 substantially extending along the first rotation axis 181. A first end of the first arm 15 is rotatably connected to the joint 14, and a second end of the first arm 15 opposite to the first end is rotatably connected to the second arm 16.

The first transmission mechanism is mounted between the first driver 21 and the end of the first arm 15 adjacent to the joint 14. The first transmission mechanism may be a three-stage transmission including a first gear 221 coupled to the output shaft of the first driver 21, a second gear 223 secured to the outer circumference of the first arm 15, and two pairs of middle gears 226. The first gear 221 is smaller than the second gear 223. The middle gears 226 are received in the receiving space 1433 and rotatably supported by corresponding bearing bases 225 fixed with the first support portion 142. Since the second gear 223 is sleeved on the outer surface of the first arm 15, the second gear 223 can achieve a relatively large diameter, thus achieving a large reduction ratio.

The second transmission mechanism is capable of transmitting the movement from the second driver 23 to the second arm 16. The second transmission mechanism includes a first shaft 241, a first single stage transmission 242 mounted between the first shaft 241 and the second driver 23, and at least one pair of gears (not labeled) between the first shaft 241 and the second arm 16 for transmitting rotation motion.

The first single stage transmission 242 includes a first gear 2421 coupled to the output shaft of the second driver 23, and a second gear 2422 mounted on the end of the first shaft 241 received in the receiving space 1433.

The third transmission mechanism is capable of transmitting the movement from the third driver 25 to the third arm 17. The third transmission mechanism includes a second shaft 261, a second single stage transmission 262 mounted between the second shaft 261 and the third driver 25, and at least one pair of gears (not labeled) between the second shaft 261 and third arm 17 for transmitting rotation motion.

The second single stage transmission 262 includes a first gear 2621 coupled to the output shaft of the third driver 23, and a second gear 2622 mounted on the end of the second shaft 261 received in the receiving space 1433.

The second shaft 261 defines a through hole 2612 extending along the axis thereof. The first shaft 241 is rotatably received in the through hole 2612 with two opposite ends extending out of the through hole 2612. The second gears 2422 and 2622 are offset in the position along the first rotation axis 181, thus reducing the outer diameter of the first arm 15. The first shaft 241 is rotatably supported by a bearing (not shown) received in the through hole 2612 of the second shaft 261. The second shaft 261 is rotatably supported by bearings 1512 received in the hollow portion 151 of the first arm 15. It should be understood that, alternatively, the first shaft 241 may define a through hole (not shown), in which the second shaft 261 is received with its two ends extending out of the through hole.

The first transmission mechanism, the first single stage transmission 242 of the second transmission mechanism, and the second single stage transmission 262 of the third transmission mechanism are received in the receiving space 1433, thus achieving a compact size and facilitating maintenance. In addition, the first, second and third transmission mechanisms can employ standard gears, thus reducing costs.

It should also be understood that the industrial robot 100 is not limited to a six-axis industrial robot, and can alternatively be industrial robots with fewer axes. For instance, the industrial robot 100 may have only three axes includes the first arm 15, the second arm 16 and the third arm 17, with the joint 14 functioning as a fixed base fixed to the ground or support.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An industrial robot comprising:
a joint;
a first arm rotatably connected to the joint about a first rotation axis, the first arm defining a hollow portion extending along the first rotation axis;
a second arm rotatably connected to the first arm about a second rotation axis;
a third arm rotatably connected to the second arm about a third rotation axis;
a first driver and a first transmission mechanism to drive the first arm;
a second driver and a second transmission mechanism to drive the second arm; and
a third driver and a third transmission mechanism to drive the third arm;
wherein the first, second and third drivers are mounted on the joint, the second transmission mechanism comprises a first shaft rotatably received in the hollow portion, and the third transmission mechanism comprises a second shaft sleeved on the first shaft.

2. The industrial robot of claim 1, wherein the joint comprises a first support portion defining a first assembly hole, and a second support portion fixed to the first support portion; an end of the first arm is received in the first assembly hole.

3. The industrial robot of claim 2, wherein the second support portion comprises a bottom surface and a sidewall extending substantially perpendicular to an outer edge of the bottom surface; wherein the bottom surface and the sidewall cooperatively define a receiving space communicating with the first assembly hole of the first support portion.

4. The industrial robot of claim 3, wherein the first transmission mechanism, at least part of the second transmission, and at least part of the third transmission mechanism are received in the receiving space.

5. The industrial robot of claim 3, wherein a side of the sidewall away from the bottom surface is fixed to the first support portion.

6. The industrial robot of claim 3, wherein the bottom surface defines three second assembly holes therein and the output shafts of the first, second and third drivers are substantially parallel and received in a corresponding second assembly hole, respectively.

7. The industrial robot of claim 1, wherein the first transmission mechanism comprises a three-stage transmission mounted between the first driver and the first arm.

8. The industrial robot of claim 7, wherein the three-stage transmission comprises a first gear coupled to an output shaft of the first driver, a second gear secured to the outer circumference of the first arm, and two pairs of middle gears positioned between the first gear and the second gear.

9. The industrial robot of claim 8, wherein the first gear of the first transmission mechanism is smaller than the second gear of the first transmission mechanism.

10. The industrial robot of claim 7, the second transmission mechanism further comprising a first single stage transmission mounted between the first shaft and the second driver, and at least one pair of gears between the first shaft and the second arm for transmitting rotation motion.

11. The industrial robot of claim 10, wherein the first single stage transmission comprises a first gear coupled to an output shaft of the second driver, and a second gear mounted on an end of the first shaft.

12. The industrial robot of claim 11, wherein the second gear of the first transmission mechanism and the second gear of the second transmission are offset in the position along the first rotation axis.

13. The industrial robot of claim 12, wherein the third transmission mechanism comprises a second single stage transmission mounted between the second shaft and the third driver, and at least one pair of gears between the second shaft and the third arm to transmit rotation motion.

14. The industrial robot of claim 13, wherein the second single stage transmission comprises a first gear coupled to an output shaft of the third driver and a second gear mounted on an end of the second shaft.

15. The industrial robot of claim 1, wherein the second shaft defines a through hole extending along the axis of the second shaft, and the first shaft is rotatably received in the through hole with two opposite ends extending out of the through hole.

16. The industrial robot of claim 1, wherein the first and third axes are substantially perpendicular to the second rotation axis.

17. An industrial robot comprising:
a joint;
a first arm rotatably connected to the joint about a first rotation axis, the first arm defining a hollow portion extending along the first rotation axis;
a second arm rotatably connected to the first arm about a second rotation axis;
a third arm rotatably connected to the second arm about a third rotation axis;
a first driver and a first transmission mechanism to drive the first arm;
a second driver and a second transmission mechanism to drive the second arm;
a third driver and a third transmission mechanism to driver the third arm; and
cables connected to the first, second and third drivers;
wherein the first, second and third drivers are mounted on the joint, a the cables are drawn from an external space of the industrial robot, the second transmission mechanism comprises a first shaft rotatably received in the hollow portion, and the third transmission mechanism comprises a second shaft sleeved on the first shaft.

18. An industrial robot comprising:
a joint;
a first arm rotatably connected to the joint about a first rotation axis, the first arm defining a hollow portion extending along the first rotation axis;
a second arm rotatably connected to the first arm about a second rotation axis;
a third arm rotatably connected to the second arm about a third rotation axis;
a first driver and a first transmission mechanism to drive the first arm;
a second driver and a second transmission mechanism to drive the second arm; and
a third driver and a third transmission mechanism to drive the third arm;
wherein the first, second and third driver are mounted on the joint, and the joint defines three assembly holes to receive output shafts of the first, second and third drivers, respectively, the second transmission mechanism comprises a first shaft rotatably received in the hollow portion, and the third transmission mechanism comprises a second shaft sleeved on the first shaft.
